(19) United States
(12) Patent Application Publication
(10) Pub. No.: US 2004/0234652 A1
(43) Pub. Date: Nov. 25, 2004

(54) Food packaging

(75) Inventor: Kendrew George Elliott, Pretoria (ZA)

Correspondence Address: WOOD, HERRON & EVANS, LLP, 2700 CAREW TOWER, 441 VINE STREET, CINCINNATI, OH, 45202, US

(73) Assignee: Burger Ring (Proprietary) Limited, Fontainebleau (ZA)

(21) Appl. No.: 10/717,837

(22) Filed: Nov. 20, 2003

(30) Foreign Application Priority Data
May 20, 2003 (ZA) 2003/3916

(51) Int. Cl. C12C 1/027

(52) U.S. Cl. 426/106

(57) ABSTRACT

A wrapper-strap for a sandwich, wherein the wrapper-strap is made of elongate foldable sheet material. The sheet material is shaped and dimensioned to fit snugly belt-fashion around the sandwich. The wrapper-strap has complementary first and second fastening formations, towards opposed ends thereof. The fastening formations permit the wrapper-strap to be fitted snugly around the sandwich by fastening the two fastening formations together.

THIS INVENTION relates to food packaging. In particular the invention relates to a wrapper-strap for a sandwich, to a food package and to a method of presenting a sandwich.

The invention provides a wrapper-strap for a sandwich, the wrapper-strap being of elongate foldable sheet material, the wrapper-strap having complementary first and second fastening formations towards opposed ends thereof to permit the wrapper-strap to be fitted snugly belt-fashion around a sandwich, by fastening the two fastening formations together.

The Inventor believes that the invention will find application particularly with hamburgers. However, it may be used with other foodstuffs and accordingly, in the context of this specification the term “sandwich” is to be interpreted broadly to include hamburgers and the like.

The first fastening formation near a first end of the wrapper-strap may include at least one slit extending transversely partly across the width of the wrapper-strap and opening out of one side thereof, and the second fastening formation may include at least one opposing slit extending transversely across the width of the wrapper-strap and opening out of the opposing side thereof, thereby to permit the ends of the wrapper-strap to be fastened together by the slits inter-engaging saddle-fashion.

The first fastening formation may include a plurality of longitudinally spaced parallel slits all of which extend partly across the width of the wrapper-strap and open out of the one side, and the second fastening formation may include a plurality of similar longitudinally spaced but opposed parallel slits, all of which extend partly across the width of the wrapper-strap and open out of the other side, thereby to permit adjustment in the peripheral length of the wrapper-strap to accommodate sandwiches of different sizes. This will permit the wrapper-strap to accommodate different types of sandwiches and to compensate for variations in size of the same type of sandwich.

The wrapper-strap may have at least one transverse fold line positioned between the fastening formations. The wrapper-strap may also include a fold line corresponding to each slit and the fold line may be parallel with and positioned midway between the corresponding slit and a centre line of the wrapper-strap. Hence, the fold line and the slots may each be arranged in two sets which are equally spaced on opposite sides of the centre line of the wrapper-strap.

The width of the wrapper-strap will be selected so that it together with a sandwich around which it is fitted can be held comfortably by a person holding the sandwich. The width of the wrapper-strap may not be greater than about 6 cm. This arrangement not only facilitates holding of the wrapper-strap but also permits it to fit inside a conventional polystyrene container in which hamburgers are often contained. Typically, the width of the wrapper-strap may be between 50 mm and 60 mm, preferably the width of the wrapper-strap may be about 53.5 mm.

The wrapper-strap may include a central panel on which signage, indicia, or written directions of use are or can be provided.

The invention also provides a food package which includes

a sandwich; and

an elongate wrapper-strap of foldable sheet material which fits snugly belt-fashion around the periphery of the sandwich.

The wrapper-strap may have a width which substantially matches an edge thickness of the sandwich.

The wrapper-strap may be a wrapper-strap of the type described above.

The sandwich is preferably a hamburger.

The invention also extends to a method of presenting a sandwich to a user which includes wrapping a wrapper-strap of the type described above around a sandwich to hold the different components of the sandwich in place, whereafter receipt of the sandwich a user can remove the strap and use it to block an opening opposite a bite side of the sandwich while eating the sandwich, thereby to prevent the filling of the sandwich from passing the opening created between layers of the sandwich opposite the bite side of the sandwich.

Further features of the invention will now become apparent, by way of example, with reference to the accompanying diagrammatic drawings.

In the drawings:

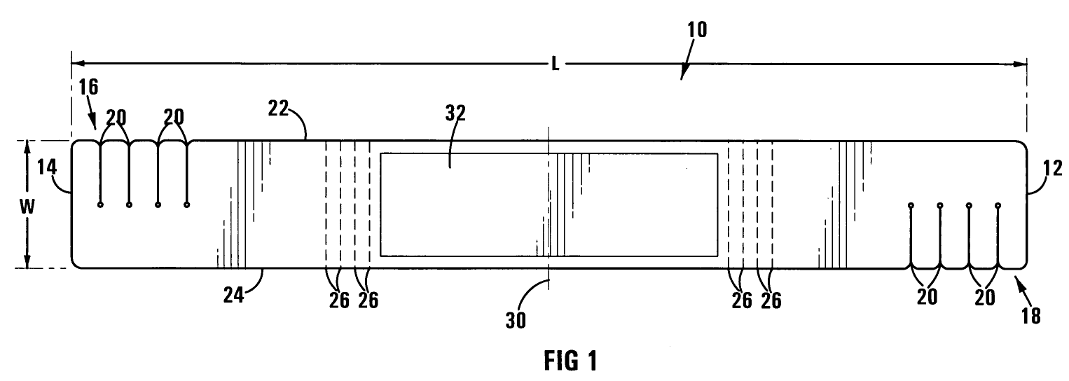

FIG. 1 shows, in plan view, a wrapper-strap in accordance with the invention;

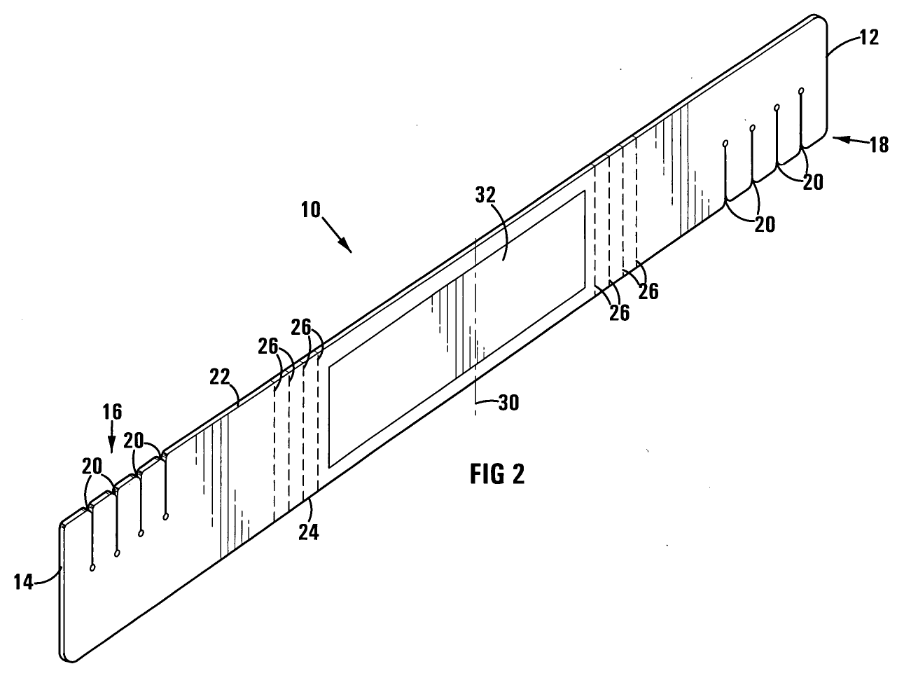

FIG. 2 shows an oblique view of the wrapper-strap shown in FIG. 1;

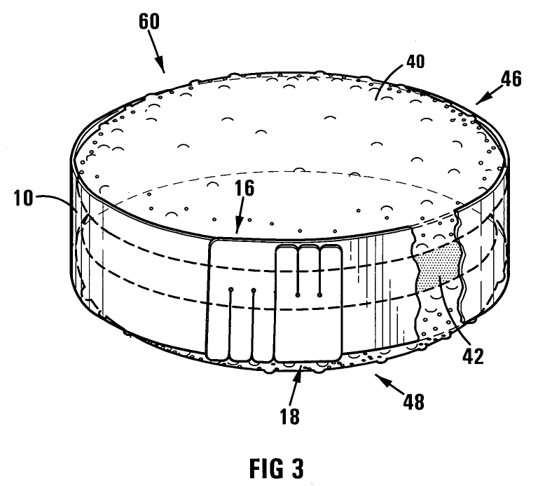

FIG. 3 shows a food package in accordance with the invention incorporating the wrapper-strap of FIGS. 1 and 2; and

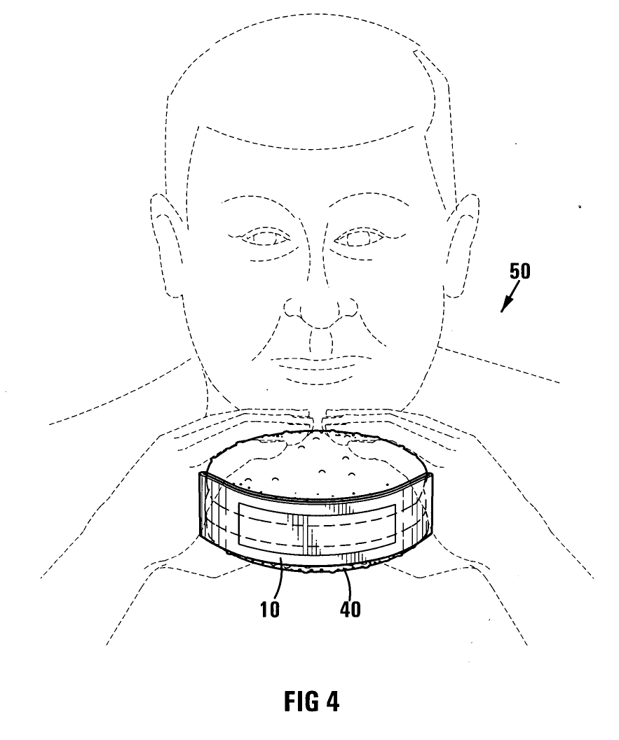

FIG. 4 shows a wrapper-strap in use by a user eating a hamburger.

In FIG. 1 and FIG. 2, a wrapper-strap, in accordance with the invention, is generally indicated by reference numeral 10. The wrapper-strap 10 is made of an elongate foldable sheet material. In a preferred embodiment, the sheet material is a light gauge food grade cardboard material. The wrapper-strap has a first fastening formation 16 near a first end 14, and a complementary second fastening formation 18 near an opposed end 12 of the wrapper-strap. The strap 10 is generally rectangular in shape having parallel sides 22, 24 extending between the ends 12, 14.

The first fastening formation 16 includes a plurality of longitudinally spaced parallel slits 20 all of which extend partly across the width of the wrapper-strap parallel with the ends 12, 14 and open out of the one side 22. The second fastening formation 18 includes a plurality of longitudinally spaced parallel slits 20, similar to those of the first fastening formation, all of which extend partly across the width of the wrapper-strap but which open out of the other side 24.

The wrapper-strap has a plurality of parallel transverse fold lines 26 positioned between the fastening formations 16 and 18. Each fold line 26 is formed by a score line formed onto the material of the strap 10. Each one of the fold lines 26 corresponds to one of the slits 20 respectively and each one of the fold lines 26 is positioned midway between the corresponding slit 20 and a centre line 30 of the wrapper-strap 10. Hence, the spacing between the fold lines 26 is half of the spacing between the corresponding slits 20.

The wrapper-strap includes a central panel 32 on which signage, indicia, or written directions of use are provided.

In FIG. 3 of the drawings, reference numeral 60 refers to a food package, in accordance with the invention. The food package 10 includes a sandwich in the form of a hamburger 40; and a wrapper-strap 10 of the type as described above. The wrapper-strap 10 is shown in FIG. 3 as fitted snugly around the hamburger 40 belt-fashion to retain the filling 42 in position. The ends of the wrapper-strap are fastened together by inter-engaging slits 20 of the fastening formations 16, 18 saddle-fashion. The reader will appreciate that the ends of the wrapper-strap may be fastened together by the inter-engaging of any of the slits 20 of the fastening formation 16 with any one of the slits 20 of the fastening formation 18, thereby to permit adjustment in the effective peripheral length of the wrapper-strap 10 to accommodate sandwiches of different shapes and sizes. To facilitate inter-engaging of the slits the mouths of the slits 20 are flared.

Naturally, the various dimensions of the wrapper-strap 10 may vary depending upon the intended application. However, the inventor belives that a wrapper-strap 10 having the following dimensions, will be suitable for use with most commercially available hamburgers. The wrapper-strap 10 typically has a length L of about 41 cm and a width W of about 5.3 cm. The spacing of the slits 20 from the centre line 30 will be 144 mm, 167 mm, 180 mm and 193 mm, respectively. The spacing of the corresponding fold lines 26 from the centre line 30 will be half of that of the corresponding slits, namely, 77 mm, 83.5 mm, 90 mm and 96.5 mm, respectively.

In use, with reference to FIG. 4 of the drawings, a user 50 who, after receipt of a food package 60 as described above wishes to consume the hamburger 40, removes the wrapper-strap 10 from the hamburger 40 by lifting it upwardly from the hamburger 40. It will be appreciated that the ends of the wrapper-strap 10 will still be connected together. The user then simply flattens the wrapper-strap 10 which is facilitated by the fold lines 26 such that its effective length has been halved. The flattened wrapper-strap is then positioned and held by the user, as illustrated in FIG. 4 of the drawings, on that side of the hamburger, opposite to the side being bitten by the user. This arrangement serves to retain the filling of the hamburger in position thereby avoiding the mess normally associated with eating of a hamburger.

The Inventor believes that a wrapper-strap 10 in accordance with the invention will not only provide a cost effective manner to assist users in eating a hamburger but in addition will provide material on which advertising matter, eg the name of a restaurant can be positioned. In addition, in view of the fact that, when not in use, the wrapper-strap is flat, it is relatively easy to store and transport.

1. A wrapper-strap for a sandwich, the wrapper-strap being of elongate foldable sheet material, the wrapper-strap having complementary first and second fastening formations towards opposed ends thereof to permit the wrapper-strap to be fitted snugly belt-fashion around a sandwich, by fastening the two fastening formations together.

2. A wrapper-strap as claimed in claim 1, wherein the first fastening formation near a first end of the wrapper-strap includes at least one slit extending transversely partly across the width of the wrapper-strap and opening out of one side thereof, and wherein the second fastening formation includes at least one opposing slit extending transversely partly across the width of the wrapper-strap and opening out of the opposing side thereof, thereby to permit the ends of the wrapper-strap to be fastened together by the slits inter-engaging saddle-fashion.

3. A wrapper-strap as claimed in claim 2, wherein the first fastening formation includes a plurality of longitudinally spaced parallel slits all of which extend partly across the width of the wrapper-strap and open out of the one side, and wherein the second fastening formation includes a plurality of similar longitudinally spaced but opposed parallel slits, all of which extend partly across the width of the wrapper-strap and open out of the other side, thereby to permit adjustment in the peripheral length of the wrapper-strap to accommodate sandwiches of different sizes.

4. A wrapper-strap as claimed in claim 2, wherein the wrapper-strap has at least one transverse fold line positioned between the fastening formations.

5. A wrapper-strap as claimed in claim 2, which includes a fold line corresponding to each slit, the fold line being parallel with and positioned midway between the corresponding slit and a centre line of the wrapper-strap.

6. A wrapper-strap as claimed in claim 1, wherein the width of the wrapper-strap is not greater than 6 cm.

7. A wrapper-strap as claimed in claim 1, wherein the width of the wrapper-strap is 53.5 mm.

8. A wrapper-strap as claimed in claim 1, wherein the wrapper-strap includes a central panel on which signage, indicia, or written directions of use are or can be provided.

9. A food package which includes
a sandwich; and
an elongate wrapper-strap of foldable sheet material which fits snugly belt-fashion around the periphery of the sandwich.

10. A food package as claimed in claim 9, in which the wrapper-strap has a width which substantially matches an edge thickness of the sandwich.

11. A food package as claimed in claim 9, in which the wrapper-strap has complementary first and second fastening formations towards opposed ends thereof to permit the wrapper-strap to be fitted snugly belt-fashion around a sandwich, by fastening the two fastening formations together.

12. A food package as claimed in claim 9, in which the sandwich is a hamburger.

13. A method of presenting a sandwich to a user which includes wrapping a wrapper-strap which is of elongate foldable sheet material and has complementary first and second fastening formations towards opposed ends around a sandwich and securing the ends of the strap together to hold the different components of the sandwich in place, whereafter receipt of the sandwich a user can remove the strap and use it to block an opening opposite a bite side of the sandwich while eating the sandwich, thereby to prevent the filling of the sandwich from passing the opening created between layers of the sandwich opposite the bite side of the sandwich.
